(19) United States
(12) Patent Application Publication
(10) Pub. No.: US 2007/0166511 A1
(43) Pub. Date: Jul. 19, 2007

(54) Barrier wall of color filter, its manufacturing method, and color filter

(75) Inventors: Yu-Ning Wang, Hsinchu (TW); Wei-Yuan Chen, Hsinchu (TW)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: ICF Technology Co., Ltd., Hsinchu City (TW)

(21) Appl. No.: 11/518,266

(22) Filed: Sep. 7, 2006

(30) Foreign Application Priority Data
Jan. 13, 2006 (TW) 095101347

(51) Int. Cl. B32B 3/10

(52) U.S. Cl. 428/137; 428/172

(57) ABSTRACT

A barrier wall (330) of a color filter includes a polysiloxane or its derivative. The polysiloxane or its derivative contains at least one siloxane unit. A manufacturing method for the barrier wall includes the steps of: providing a transparent substrate (310); forming a photoresist layer (300) on the substrate, the photoresist layer including a polysiloxane or its derivative, the polysiloxane or its derivative containing at least one siloxane unit; arranging a photomask (360) between the photoresist layer and a light source (370) and exposing the photoresist layer; and developing the photoresist layer and forming the barrier wall. A color filter includes a substrate and a plurality of sub-pixels each defined by a barrier wall. The barrier wall includes a polysiloxane or its derivative. The polysiloxane or its derivative contains at least one siloxane unit. Each sub-pixel carries a color ink (e.g., R, G, or B) therein.

### BACKGROUND

1. Technical Field

The present invention relates to barrier walls of color filters, color filters using the barrier walls, methods for their manufacture, and, more particularly, to a barrier wall with a proper contact angle between the barrier wall and ink.

2. Description of the Related Art

A color filter is an important element of a liquid crystal display (LCD). The color filter is used for improving picture quality and providing a primary color to each pixel of the LCD. The color filter generally includes a glass substrate, a black matrix formed on a surface of the glass substrate, a color layer formed of red (R) color portions, green (G) color portions and blue (B) color portions, and a transparent electrically conductive layer covering the black matrix and the color layer. The black matrix defines a plurality of sub-pixels of the color filter. Every sub-pixel accommodates one color portion chosen from R, G, and B color portions.

The color filters are generally manufactured via a method called “pigment-dispersed method”. The normal process of pigment-dispersed method has four repeated cycles. Wherein, each cycle contains a spin coating process or slit coating process for one selected color, a pre-bake and exposing process to solidify the selected color position to be a uniform color layer, a developing process to transform the uniform color layer to be a patterned film, and a heating process to transform the patterned film to be a solidified layer. After one color cycle is finished, another color cycle is performed. Therefore, four cycles are repeated to be the black matrix, red color portion, blue color portion, and green color portion. Since the total process steps will be more than 25 steps, the processing cost is high.

A newer manufacturing method for color filters is an ink jet method. The ink jet method mainly includes a step of depositing an ink composition on prescribed sub-pixels on a transparent substrate defined by a black matrix via an ink jet head. When this method is employed, the required amount of ink can be applied onto a required place at a specific time. Accordingly, there is no waste of ink. Furthermore, since the R, G, and B sub-pixels can be formed simultaneously, the printing process is shortened, and it is possible to markedly reduce cost.

Referring to FIG. 7, in a color filter manufactured by the ink jet method, each sub-pixel 100 must be defined by a barrier wall 130 with a height larger than that of the conventional black matrix. The barrier wall 130 is located on a transparent substrate 110 and is a dual layer including a bottom layer 132 made of a black matrix material and a top layer 234 made of a macromolecular material. The barrier wall 130 is configured for preventing ink 140 in the sub-pixel 100 from overflowing into an adjacent sub-pixel and mixing with ink in the adjacent sub-pixel. However, because of the difference of the surface energy between the barrier wall 130 and the ink 140, a contact angle θ between this barrier wall 130 and the ink 140 generally is low, and the ink 140 tends to adhere to the barrier wall 130. Therefore, a thickness of the solidified ink 140 is typically uneven. This can cause the defects in the color filter.

What is needed, therefore, is a barrier wall with a proper contact angle between the barrier wall and the ink, its manufacturing method, and a color filter using such a barrier wall.

### SUMMARY

A barrier wall of a color filter according to an embodiment includes a polysiloxane or its derivative. The polysiloxane or its derivative contains at least one siloxane unit.

A manufacturing method for a barrier wall of a color filter according to an embodiment includes the steps of: providing a transparent substrate; forming a first photoresist layer on the substrate, the first photoresist layer including a polysiloxane or its derivative, the polysiloxane or its derivative containing at least one siloxane unit; arranging a photomask between the first photoresist layer and a light source and exposing the first photoresist layer; and developing (i.e., chemical treatment of the exposed material) the first photoresist layer and forming the first barrier wall.

Another manufacturing method for a barrier wall of a color filter according to an embodiment includes the steps of providing a transparent substrate; forming a first photoresist layer on the substrate; arranging a photomask between the first photoresist layer and a light source and exposing the photoresist layer; developing the photoresist layer and forming the barrier wall; forming a second photoresist layer on an outer surface of the barrier wall, the second photoresist layer including a polysiloxane or its derivative, the polysiloxane or its derivative containing at least one siloxane unit; and solidifying the second photoresist layer.

A color filter according to an embodiment includes a substrate and a plurality of sub-pixels each defined by a barrier wall. The barrier wall includes a polysiloxane or its derivative. The polysiloxane or its derivative contains at least one siloxane unit. Each barrier wall at least partially defines a space for a given sub-pixel, the space being configured for receiving ink therein, and at least one such space has a colored ink deposited therein.

Other advantages and novel features will become more apparent from the following detailed description of the present barrier wall, its manufacturing method, and color filter, when taken in conjunction with the accompanying drawings.

### BRIEF DESCRIPTION OF THE DRAWINGS

Many aspects of the present barrier wall, its manufacturing method, and color filter can be better understood with reference to the following drawings. The components in the drawings are not necessarily to scale, the emphasis instead being placed upon clearly illustrating the principles of the present barrier wall, its manufacturing method, and color filter. Moreover, in the drawings, like reference numerals designate corresponding parts throughout the several views.

FIGS. 1a to 1c illustrate a manufacturing method of a barrier wall of a color filter, in accordance with a first embodiment;

FIGS. 2a to 2f illustrate a manufacturing method of a barrier wall of a color filter, in accordance with a second embodiment;

FIGS. 3a to 3d illustrate a manufacturing method of a barrier wall of a color filter, in accordance with a third embodiment;

FIGS. 4a to 4d illustrate a manufacturing method of a color filter, in accordance with a fourth embodiment;

FIG. 5 is a schematic, cross-sectional view of a sub-pixel unit of a color filter, in accordance with a fifth embodiment;

FIG. 6 is a schematic, cross-sectional view of a sub-pixel unit of a color filter, in accordance with a sixth embodiment; and

FIG. 7 is a schematic, cross-sectional view of a sub-pixel unit of a conventional color filter.

### DETAILED DESCRIPTION OF PREFERRED EMBODIMENTS

Reference will now be made to the drawings to describe a preferred embodiment of the barrier wall, color filter, and their manufacturing methods, in detail.

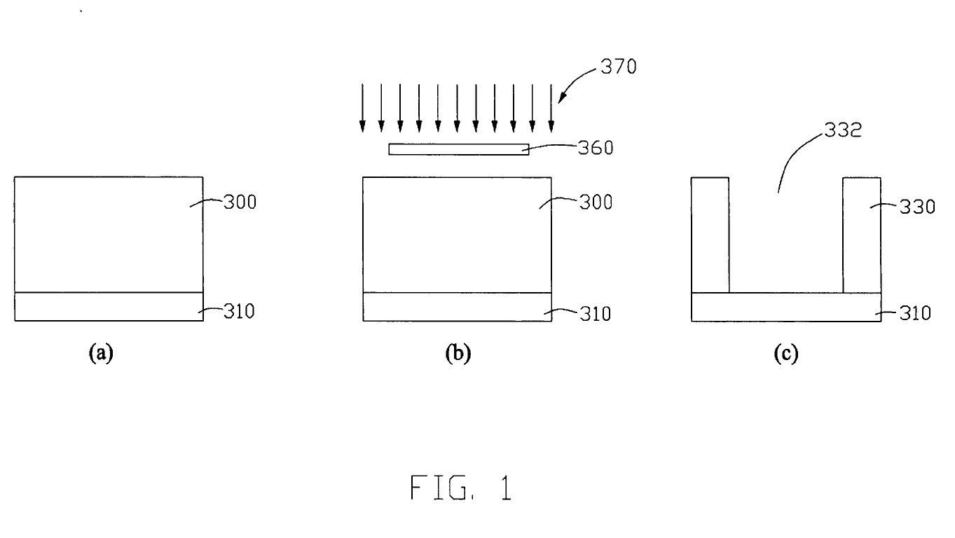

Referring to FIGS. 1a to 1c, a manufacturing method of a barrier wall of a color filter, in accordance with a first embodiment, includes the following steps, respectively illustrated by FIGS. 1a to 1c.

FIG. 1a illustrates a step of providing a transparent substrate 310 and forming a negative type photoresist layer 300 on the substrate 310. The substrate 310 can be, for example, a glass substrate. The photoresist layer 300 can be formed on the substrate 310 using a coating method or another deposition means. A material of the photoresist layer 300 includes a polysiloxane represented by the following formula (1):

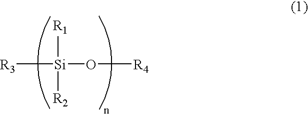

wherein R₁ and R₂ can each represent separate alkyl or phenyl groups, R₃ and R₄ can each separately represent an organic functional group including C, H, O or N (i.e., at least one of C, H, O, and N), and n represents an integer equal to or larger than 1. Generally, each of R₃ and R₄ can be one selected from the group consisting of RNH₂, RNHR, ROH, RCOOH, ROR, RCOOR, NH₂, NHR, OH, COOH, OR and COOR, where R represents an alkyl.

FIG 1b illustrates a step of arranging a photomask 360 with a pattern between the photoresist layer 300 and a light source 370 and exposing the photoresist layer 300. The light source 370 can be, e.g., an ultraviolet light source. A portion of the photoresist layer 300, which is to be formed into a barrier wall, is exposed, and the other portion of the photoresist layer 300 is left unexposed.

FIG 1c illustrates a step of developing the unexposed portion of the photoresist layer 300 and forming the barrier wall 330. In this step, the unexposed portion of the photoresist layer 300 is removed by developing. The barrier wall 330 is formed via solidifying the residual portion of the photoresist layer 300. A space 332, associated with a particular sub-pixel, is defined by the barrier wall 330 and is used for receiving a jetted ink therein. If the above photoresist layer 300 comprises carbon black or other black colorants, it can be used as black matrix.

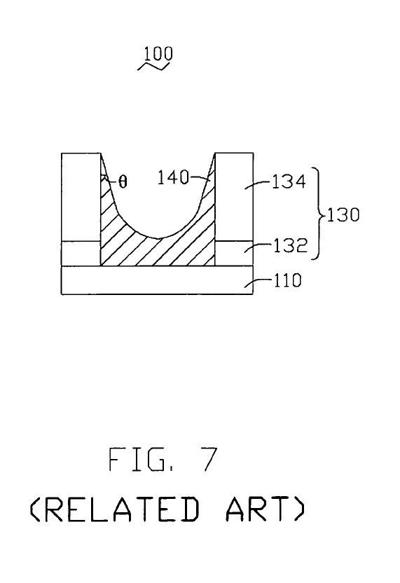

As is known in the art, a positive type photoresist layer and a complementary photomask can alternatively be used for making the barrier wall 330, and a black matrix (referring to FIG. 7) can also be formed on the substrate 310, so that the barrier wall 330 can be formed on the black matrix. The material of the photoresist layer 300 can further include at least one material selected from the group consisting of acrylic resin, polyimide, epoxy resin, and polyvinyl alcohol.

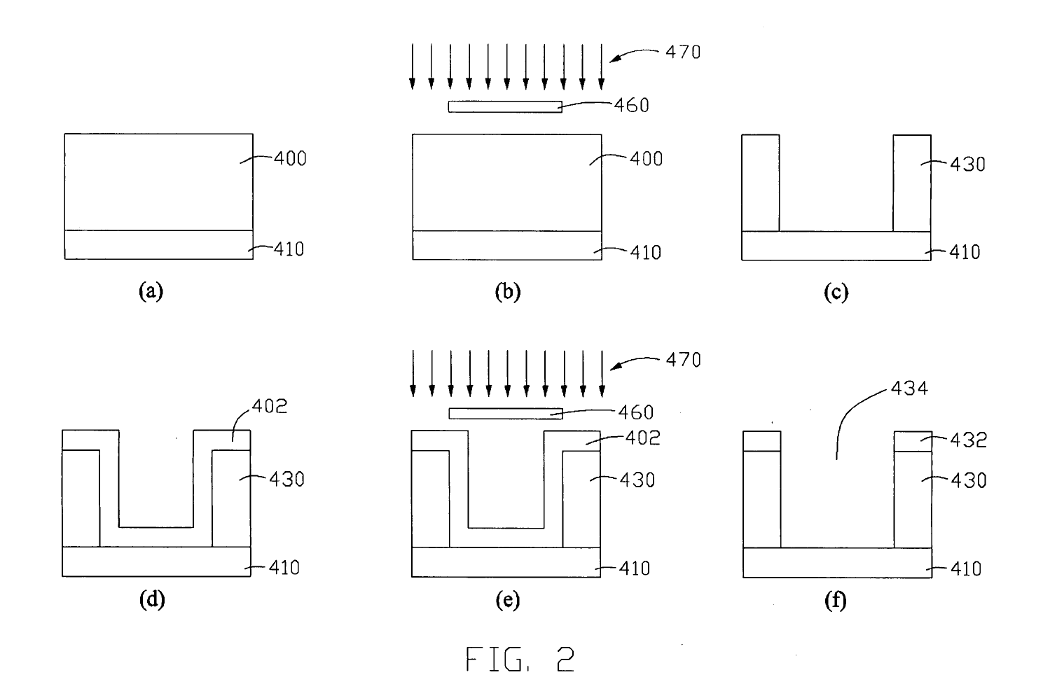

Referring to FIGS. 2a to 2f, a manufacturing method of a barrier wall of a color filter, in accordance with a second embodiment, includes the following steps, respectively illustrated by FIGS. 2a to 2f.

FIG. 2a illustrates a step of providing a transparent substrate 410 and forming a first photoresist layer 400 on the substrate 410. The substrate 410 can be a glass substrate. The photoresist layer 400 can be formed on the substrate 410 using a coating or other deposition method. The first photoresist layer 400 is a negative type photoresist, and a material thereof can include at least one material selected from the group consisting of acrylic resin, polyimide, epoxy resin, polyvinyl alcohol, and polysiloxane represented by above-mentioned formula (1).

FIG. 2b illustrates a step of arranging a photomask 460 with a pattern between the photoresist layer 400 and a light source 470 and exposing the photoresist layer 400. The light source 470 can beneficially be an ultraviolet light source. A portion of the photoresist layer 400, which is to be formed into a bottom barrier wall, is exposed, and the other portion of the photoresist layer 400 is left unexposed.

FIG. 2c illustrates a step of developing the unexposed portion of the photoresist layer 400 and forming the bottom barrier wall 430. In this step, the unexposed portion of the photoresist layer 400 is removed by developing. The bottom barrier wall 430 is formed via solidifying the residual portion of the photoresist layer 400.

FIG. 2d illustrates a step of forming a second photoresist layer 402 on the bottom barrier wall 430 and the substrate 410. The photoresist layer 402 can be formed using a coating or other deposition method. The photoresist layer 402 may include a polysiloxane represented by above-mentioned formula (1).

FIGS. 2e and 2f, respectively, illustrate steps of exposing the photoresist layer 402 and removing the unnecessary portion of the photoresist layer 402 through developing. A top barrier wall 432 is formed via solidifying the residual portion of the photoresist layer 402. A space 434 is cooperatively defined by the bottom barrier wall 430 and the top barrier wall 432, and that space 434 is used for receiving ink therein.

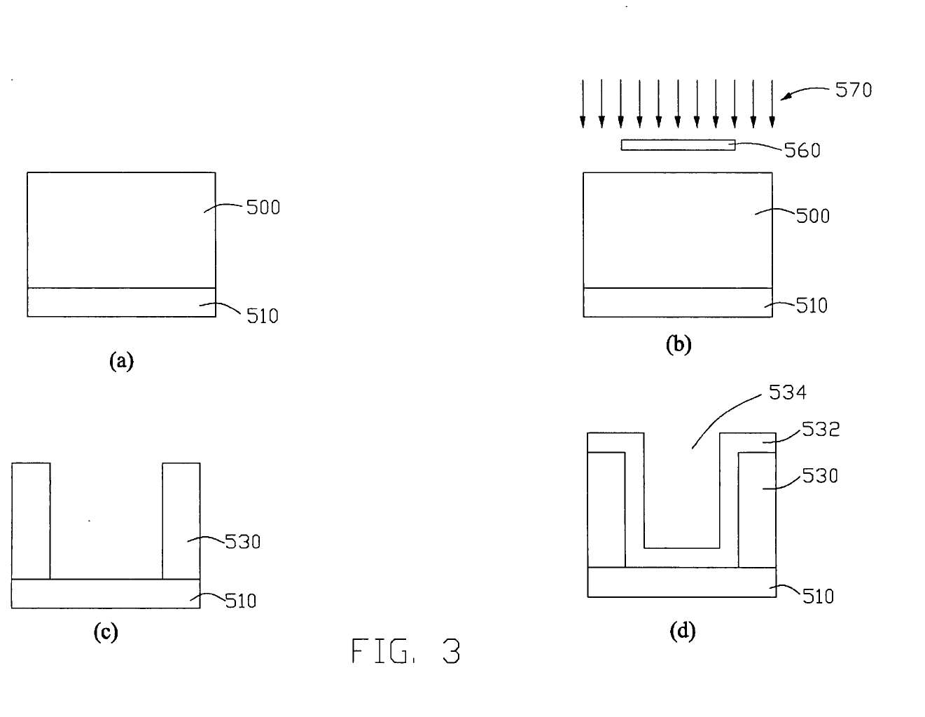

Referring to FIGS. 3a to 3d, a manufacturing method of a barrier wall of a color filter, in accordance with a third embodiment, includes the following steps, respectively illustrated by FIGS. 3a to 3d.

FIG. 3a illustrates a step of providing a transparent substrate 510 and forming a first photoresist layer 500 on the substrate 510. The substrate 510 can be a glass substrate. The photoresist layer 500 can be formed on the substrate 510 using a coating method. The first photoresist layer 500 is a negative type photoresist, and a material thereof can include at least one material selected from the group consisting of acrylic resin, polyimide, epoxy resin, polyvinyl alcohol, and a polysiloxane represented by above-mentioned formula (1).

FIG. 3b illustrates a step of arranging a photomask 560 with a pattern between the photoresist layer 500 and a light source 570 and exposing the photoresist layer 500. The light source 570 can, for example, be an ultraviolet light source. A portion of the photoresist layer 500 to be formed into a barrier wall is exposed, and the other portion of the photoresist layer 500 is unexposed.

FIG. 3c illustrates a step of developing the unexposed portion of the photoresist layer 500 and forming the barrier wall 530. In this step, the unexposed portion of the photoresist layer 500 is removed by developing. The barrier wall 530 is formed via solidifying the residual portion of the photoresist layer 500.

FIG. 3d illustrates a step of forming a second photoresist layer 532 on the barrier wall 530 and the substrate 510. The photoresist layer 532 can be formed using a coating method and then solidified using ultraviolet light. A material of the second photoresist layer 532 includes a polysiloxane represented by above-mentioned formula (1). A space 534 is defined by the photoresist layer 532 and is configured for receiving jetted ink therein.

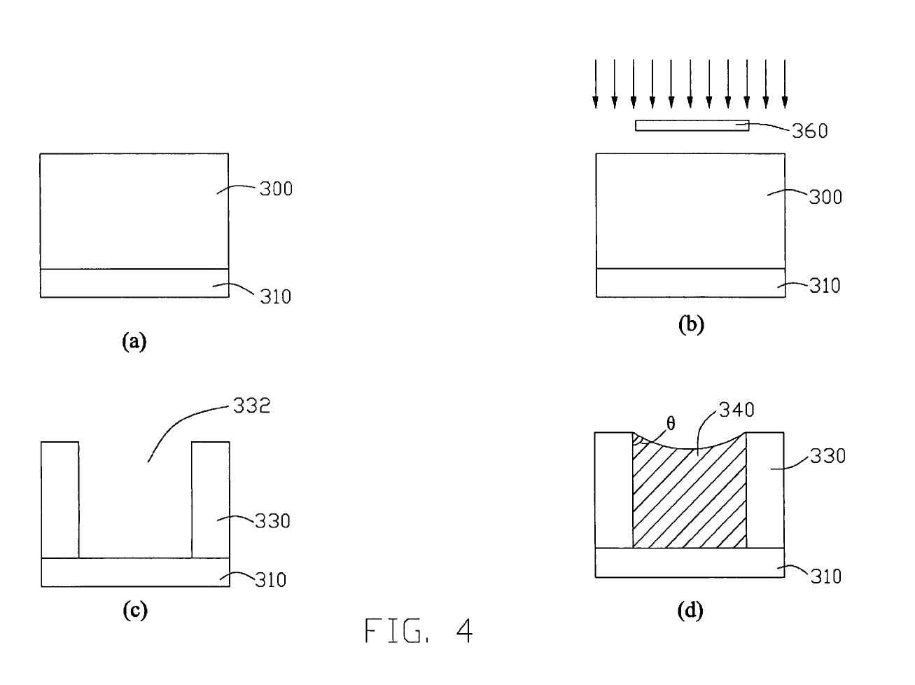

Referring to FIGS. 4a to 4d, a manufacturing method of a color filter, in accordance with a fourth embodiment, includes the following steps, respectively illustrated by FIGS. 4a to 4d.

FIGS. 4a to 4c illustrate a barrier wall forming method similar to the method illustrated in FIGS. 1a to 1c. FIG. 4d illustrates a step of jetting ink 340 into the space 332 via an ink jet device, such as a thermal bubble ink jet printing apparatus or a piezoelectric ink jet printing apparatus. Because the barrier wall 330 includes polysiloxane represented by above-mentioned formula (1), a contact angle θ between the ink 340 and the barrier wall 330 can be equal to or larger than about 40 degrees, due to the surface tension therebetween. After the ink 340 jetted in the space 332 is solidified, a color layer with an even or an essentially even thickness can be achieved.

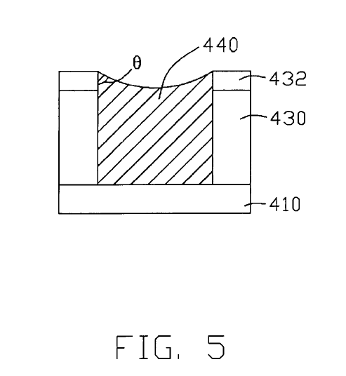

Referring to FIGS. 2 and 5, a manufacturing method of a color filter, in accordance with a fifth embodiment, includes the following steps: forming the bottom barrier wall 430 and the top barrier wall 432 according to a method similar to that illustrated in FIGS. 2a to 2f, and jetting ink 440 into the space 434 defined by the bottom barrier wall 430 and the top barrier wall 432 via an ink jet device, such as a thermal bubble ink jet printing apparatus or a piezoelectric ink jet printing apparatus. Because the barrier wall 430 includes polysiloxane represented by the above-mentioned formula (1), a contact angle θ between the ink 440 and the barrier wall 430 typically can be equal to or larger than about 40 degrees. After the ink 440 jetted in the space 434 is solidified, a color layer with an even or at least essentially even thickness is achieved.

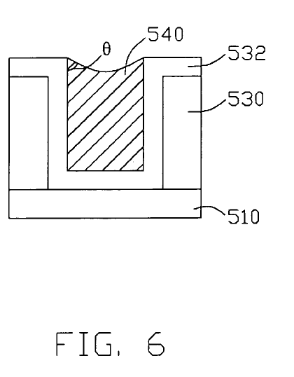

Referring to FIGS. 3 and 6, a manufacturing method of a color filter, in accordance with a sixth embodiment, includes the following steps: forming the barrier wall 530 and the photoresist layer 532 according to a method similar to that illustrated in FIGS. 3a to 3d; and jetting ink 540 into the space 534 via an ink jet device, such as a thermal bubble ink jet printing apparatus or a piezoelectric ink jet printing apparatus. Because the photoresist layer 532 includes polysiloxane represented by the above-mentioned formula (1), a contact angle θ between the ink 540 and the photoresist layer 532 can be equal to or larger than about 40 degrees. After the ink 540 jetted in the space 534 is solidified, a color layer with an even or nearly even thickness is achieved.

A derivative of above-mentioned polysiloxane can also be a material of the present barrier wall. The derivative preferably is a copolymer formed by a plurality of different repeating units. At least one unit is siloxane represented by the following formula (2):

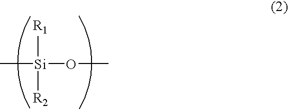

It is to be understood that the above-described embodiment is intended to illustrate rather than limit the invention. Variations may be made to the embodiment without departing from the spirit of the invention as claimed. The above-described embodiments are intended to illustrate the scope of the invention and not restrict the scope of the invention.

What is claimed is:

1. A barrier wall of a color filter, comprising a polysiloxane or its derivative, the polysiloxane or its derivative containing at least one repeating unit represented by the following formula 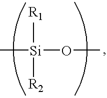
wherein R₁ and R₂ can each separately represent an alkyl or phenyl group.

2. The barrier wall of a color filter as claimed in claim 1, wherein the polysiloxane is represented by the following formula 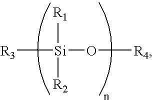
R₃ and R₄ can each represent separate organic functional groups including C, H, O or N, and n represents an integer equal to or larger than 1.

3. The barrier wall of a color filter as claimed in claim 2, wherein R₃ and R₄ can each be separately selected from the group consisting of RNH₂, RNHR, ROH, RCOOH, ROR, RCOOR, NH₂, NHR, OH, COOH, OR and COOR, where R represents an alkyl.

4. The barrier wall of a color filter as claimed in claim 1, wherein the derivative of polysiloxane is a copolymer formed by a plurality of different repeating units.

5. The barrier wall of a color filter as claimed in claim 1, further comprising at least one material selected from the group consisting of acrylic resin, polyimide, epoxy resin, and polyvinyl alcohol.

6. The barrier wall of a color filter as claimed in claim 1, wherein the barrier wall is a dual layer including a bottom layer and a top layer, the material of polysiloxane or its derivative being contained in the top layer.

7. The barrier wall of a color filter as claimed in claim 1, wherein the barrier wall includes a bottom layer and a photoresist layer formed on an outer surface of the bottom layer, the material of polysiloxane or its derivative being contained in the photoresist layer.

8. A manufacturing method for a barrier wall of a color filter, comprising the steps of.
providing a transparent substrate;
forming a first photoresist layer on the substrate, the first photoresist layer comprising a polysiloxane or its derivative, the polysiloxane or its derivative containing at least one repeating unit represented by the following formula 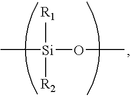
wherein R₁ and R₂ can each represent a separate alkyl or phenyl;
arranging a photomask between the first photoresist layer and a light source and exposing the first photoresist layer; and
developing the first photoresist layer and forming the first barrier wall.

9. The manufacturing method as claimed in claim 8, wherein the polysiloxane is represented by the following formula 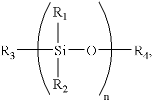
wherein each of R₃ and R₄ can represent separate organic functional groups including C, H, O or N, and n represents an integer equal to or larger than 1.

10. The manufacturing method as claimed in claim 9, wherein R₃ and R₄ can each be separately selected from the group consisting of RNH₂, RNHR, ROH, RCOOH, ROR, RCOOR, NH₂, NHR, OH, COOH, OR and COOR, where R represents an alkyl.

11. The manufacturing method as claimed in claim 8, wherein the derivative of polysiloxane is a copolymer formed by a plurality of different repeating units.

12. The manufacturing method as claimed in claim 8, wherein the first photoresist layer further comprises at least one material selected from the group consisting of acrylic resin, polyimide, epoxy resin, and polyvinyl alcohol.

13. The manufacturing method as claimed in claim 8, wherein a black matrix is formed on the substrate, and the first barrier wall is formed on the black matrix.

14. The manufacturing method as claimed in claim 8, further comprising a step of forming a second barrier wall between the substrate and the first barrier wall.

15. The manufacturing method as claimed in claim 14, wherein the second barrier wall is formed by the following method:
forming a second photoresist layer on the substrate;
arranging a photomask between the second photoresist layer and a light source and exposing the second photoresist layer; and
developing the second photoresist layer and forming the second barrier wall.

16. The manufacturing method as claimed in claim 15, wherein a material of the second photoresist layer comprises at least one substance selected from the group consisting of acrylic resin, polyimide, epoxy resin, polyvinyl alcohol, the polysiloxane, and the derivative of the polysiloxane.

17. The manufacturing method as claimed in claim 8, wherein the first photoresist layer further comprises carbon black or other black colorants.

18. A manufacturing method for a barrier wall of a color filter, comprising the steps of:
providing a transparent substrate;
forming a first photoresist layer on the substrate;
arranging a photomask between the first photoresist layer and a light source and exposing the photoresist layer;
developing the photoresist layer and forming the barrier wall;
forming a second photoresist layer on an outer surface of the barrier wall, the second photoresist layer comprising a polysiloxane or its derivative, the polysiloxane or its derivative containing at least one repeating unit represented by the following formula 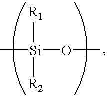
wherein R₁ and R₂ can each separately represent an alkyl or phenyl group; and
solidifying the second photoresist layer.

19. The manufacturing method as claimed in claim 18, wherein the polysiloxane is represented by the following formula 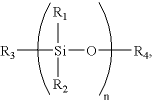
wherein R₃ and R₄ can each represent separate organic functional groups including C, H, O or N, and n represents an integer equal to or larger than 1.

20. The manufacturing method as claimed in claim 18, wherein the derivative of polysiloxane is a copolymer formed by a plurality of different repeating units.

21. A color filter, comprising a substrate and a plurality of sub-pixels each defined by a barrier wall, the barrier wall comprising a polysiloxane or its derivative, the polysiloxane or its derivative containing at least one repeating unit represented by the following formula 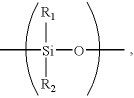
wherein R1 and R2 can each separately represent alkyl or phenyl, each barrier wall at least partially defining a space configured for receiving ink therein, at least one such space having a colored ink deposited therein.

22. The color filter as claimed in claim 21, wherein the polysiloxane is represented by the following formula 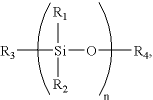
R3 and R4 can each separately represent organic functional groups including C, H, O or N, and n represents an integer equal to or larger than 1.

23. The color filter as claimed in claim 22, wherein each of R₃ and R₄ can be one selected from the group consisting of RNH₂, RNHR, ROH, RCOOH, ROR, RCOOR, NH₂, NHR, OH, COOH, OR and COOR, wherein R represents an alkyl.

24. The color filter as claimed in claim 21, wherein the derivative of polysiloxane is a copolymer formed by a plurality of different repeating units.

25. The color filter as claimed in claim 21, wherein the barrier wall further comprises at least one material selected from the group consisting of acrylic resin, polyimide, epoxy resin, and polyvinyl alcohol.

26. The color filter as claimed in claim 21, wherein the barrier wall is a dual layer including a bottom layer and a top layer, the material of polysiloxane or its derivative being contained in the top layer.

27. The color filter as claimed in claim 21, wherein the barrier wall includes a bottom layer and a photoresist layer formed on an outer surface of the bottom layer, the material of polysiloxane or its derivative being contained in the photoresist layer.
